(19) United States
(12) Patent Application Publication
(10) Pub. No.: US 2025/0138908 A1
(43) Pub. Date: May 1, 2025

(54) HIERARCHICAL COLLABORATION PLANNING FEATURE INTEGRATION

(71) Applicant: NCR Voyix Corporation, Atlanta, GA (US)

(72) Inventors: Michael Jonathon McKaig, Dundee (GB); Ian Maxwell Joy, St Andrews (GB)

(21) Appl. No.: 18/385,599

(22) Filed: Oct. 31, 2023

(51) Int. Cl. G06F 9/54

(52) U.S. Cl. CPC G06F 9/541

(57) ABSTRACT

A plugin is provided to a collaboration service. The plugin permits defining a hierarchical meeting that includes one or more sub meetings. The hierarchical meeting is defined via a graphical user interface of the plugin. Once defined, the hierarchical meeting and sub meetings are provided to the collaboration service as multiple meetings which the collaboration service schedules. The plugin is activated by the collaboration service when a user attempts to modify any of the meetings by selecting a corresponding meeting entry off the user's calendar. Assuming the user has proper access rights, the plugin permits changes by the user, translates the changes into a format recognized by the collaboration service, and provides the formatted changes to the collaboration service for making the changes on the calendar and other calendars associated with other users who are attendees affected by the changes.

### BACKGROUND

In today's digital era, a plethora of meeting tools, social media applications (apps), and messaging apps exist for individuals to collaborate with one another. Many of these tools and apps include meeting or scheduling features. However, meetings can be large, cross-functional, or intra-departmental with structured agendas, and dedicated presentation timeslots. For example, a single large overarching inter-departmental meeting between multiple departments within an organization may require several individual intra-departmental meetings for each of the individual departments. Each intra-departmental meeting has to be managed independently and separately within the overarching inter-departmental meeting.

### BRIEF DESCRIPTION OF THE DRAWINGS

FIG. 1 is a diagram of a system for hierarchical collaboration planning feature integration, according to an example embodiment.

FIG. 2 is a diagram of a method for hierarchical collaboration planning feature integration, according to an example embodiment.

FIG. 3 is a diagram of another method for hierarchical collaboration planning feature integration, according to an example embodiment.

### DETAILED DESCRIPTION

Existing collaboration tools do not provide features that allow for effective scheduling and management of overarching meetings or events. Often in order to schedule an overarching meeting with these existing tools, the meeting organizer needs to block out all of attendees' calendar availabilities for a significant amount of time even when some of the attendees are needed for a smaller amount of time. If the meeting organizer cannot do this based on the availabilities of certain attendees, then the meeting organizer is required to schedule several independent and sub meetings such that each meeting accommodates the needed attendees, which is inefficient and difficult to manage when changes are needed to either the overarching meeting and/or one or more of the sub meetings. For example, in Microsoft® Teams®, if there were back-to-back sub meetings, each with exactly the same attendee list, it is inefficient for the attendees to manually exit the first meeting just to join the second meeting.

With existing collaboration tools, all meetings must be managed and executed individually by the tools such that if for any reason a meeting needs to be rescheduled or canceled, each of the individual meetings has to be updated or canceled. For large overarching meetings, changes or cancelations are time consuming administrative activities, which are fraught with potential mistakes and woefully inefficient. Additionally, with existing collaboration tools resources cannot be shared between individually scheduled meetings associated with an overarching meeting. For example, there is no ability to provide a single link for multiple meetings for a single chat room or video conference. Furthermore, with existing tools, attendees must be managed on a per meeting basis, rather than having a feature to add attendees to all the meetings or to add certain attendees just to certain meetings. Again, for an overarching meeting with sub meetings, existing tools require that each of the meetings and each meeting's resources be scheduled and managed individually.

These issues are solved with the teachings provided herein. A self-contained set of collaboration features is provided as a plugin enhancement to existing collaboration tools. At least one of the collaboration features includes custom defining an overarching hierarchical meeting object or data structure, which includes definitions for sub meeting objects. The overarching hierarchical meeting object includes attributes that are selectively inherited/shared or not inherited/shared by various levels of the sub meeting objects. A meeting organizer or user interactively builds the overarching hierarchical meeting object when user selects a new meeting type from an enhanced user interface of an existing collaboration tool. The existing collaboration tool is enhanced to include the new meeting type as an option within the user interface and further enhanced to initiate the plugin (i.e., self-contained set of collaboration features described herein) when the option is selected by the user. The plugin includes its own graphical user interface which permits the user to select, browse, search, and/or enter overarching and sub meeting criteria; for example, meeting calendar date, meeting time of day, meeting length, meeting attendees, attendee authorizations, meeting resources (e.g., attached documents, links to documents, links to video sessions, links to chat rooms, etc.), meeting summary information, and meeting attributes (i.e., shared or not shared) for the meeting resources.

Once the meeting is defined by the user, the plugin uses an application programming interface (API) to insert the overarching meeting and sub meetings into the calendar data structure used by the enhanced collaboration tool for the meeting organizer. The plugin also uses the API to provide a message or messages with details about the corresponding meeting to the enhanced collaboration tool for delivery to the corresponding attendees. The calendar entries for the meeting organizer or the calendar entries for any attendee delegated authority (i.e., proper attendee authorizations) to modify any of the meeting(s) include an enhanced option to initiate the plugin's GUI when selected by a user off the user's corresponding calendar data structure. Changes made by an authorized user to the overarching meeting object and/or any of the sub meeting objects via the plugin's GUI are provided via the API to the enhanced collaboration tool for updates, cancelations, and/or revised attendee messages as needed.

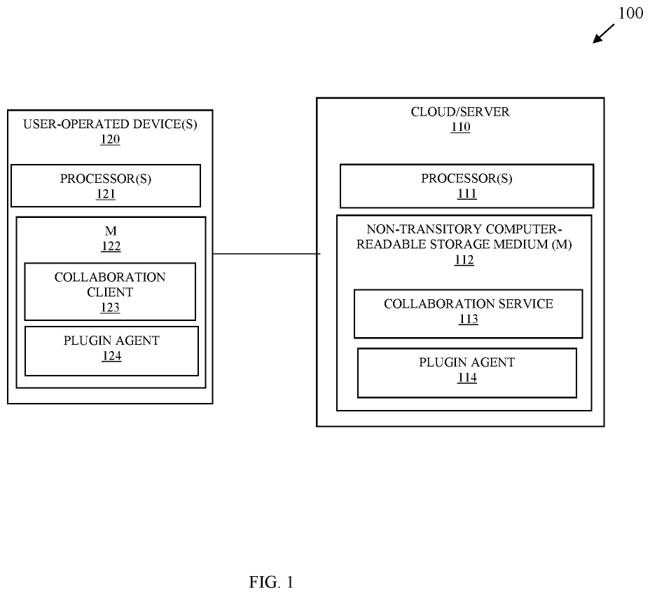

FIG. 1 is a diagram of a system/platform 100 for hierarchical collaboration planning feature integration, according to an example embodiment, according to an example embodiment. Notably, the components are shown schematically in greatly simplified form, with just those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of hierarchical collaboration planning feature integration, presented herein and below.

System 100 includes a cloud 110 or a server 110 (hereinafter just “cloud 110) and user devices 120. Cloud 110 includes at least one processor 111 and a non-transitory computer readable storage medium (herein after just “medium) 112, which includes instructions for a collaboration service 113 and a plugin agent 114. The instructions when executed by the processor 111 cause the processor to perform operations discussed herein and below with respect to 113 and 114.

Each user-operated device 120 includes at least one processor 121 and medium 122, which includes instructions for a collaboration client 123 and a plugin agent 124. The instructions when executed by the processor 121 cause the processor to perform operations discussed herein and below with respect to 123 and 124.

Collaboration service 113 is an existing collaboration service enhanced to support plugin agent 114. In an embodiment, collaboration service 113 is an email and calendar service, such as Gmail®, Outlook®, Apple® mail and calendar service, Yahoo® mail and calendar service, etc. Collaboration service 113 is enhanced to support hierarchical collaboration features provided by plugin agent 124 and plugin agent 114. Similarly, collaboration client 123 is an existing collaboration service enhanced to support plugin agent 124.

Plugin agent 114 and plugin agent 124 are integrated into collaboration service 113 and collaboration client 123 via an API. The Plugin agent 114 and plugin agent 124 use the API to provide calendar data structures and calendar scheduling messages to be processed by the collaboration service 113 and the collaboration client 123.

The user interface associated with the collaboration client 123 is enhanced to support a new type of meeting, which is provided by plugin agent 124. That is, when a user is interacting with the user interface of collaboration client 123 and initiates an option to insert a meeting into a calendar data structure of the collaboration client 123, the user is presented an option to insert or create a hierarchical meeting. When the user selects the hierarchical meeting type, the collaboration client initiates or calls the plugin agent 124.

Once initiated, plugin agent presents a GUI to the user for defining a hierarchical meeting object. The user is provided GUI options to select from a list, browse a list, search a list, and or manually enter into an input field meeting criteria, meeting resources, meeting attributes, and attendee authorizations for the hierarchical meeting object. This includes, by way of example only, defining sub meeting objects for sub meetings within the overall hierarchical meeting object. The meeting criteria includes, by way of example only, and for both the hierarchical meeting object and any sub meeting objects, calendar date(s), time of day, length, and meeting description or subject, user (e.g., meeting organizer provided information). The meeting resources include, by way of example only, links to a video conference tool or service, links to a chat room, and any documents uploaded as attachments by the user. The meeting attributes include, by way of example only, a flag set on the meeting resources indicating whether a corresponding meeting resource is sharable or not sharable between the hierarchical meeting and the sub meetings. In an embodiment, the flag is multi value character that permits a given resource to be shared from the hierarchical meeting to select ones or combinations of the sub meetings, and that permits a given resource of a sub meeting to be shared back with the hierarchical meeting and/or with a combination of the hierarchical meeting and one or more other sub meetings. The meeting attendees are email or messaging addresses for the attendees of the hierarchical meeting and of each of the sub meetings. The attendee authorizations include, by way of example, access rights for modifications to the hierarchical meeting object and/or one or more of the sub meeting objects. For example, a meeting organizer access right permits an attendee identified in the meeting attendees to modify the hierarchical meeting object; a sub meeting organizer access right permits an attendee of a corresponding sub meeting to modify the corresponding sub meeting object. The access rights can also permit a given attendee to add additional attendees to the hierarchical meeting and/or to specific sub meetings.

Once the user had defined the hierarchical meeting and the sub meetings through providing the meeting criteria, meeting resources, meeting attributes, and attendee authorizations, the plugin agent 124 creates the hierarchical meeting object and the sub meeting objects as data structures. Plugin agent 124 parses the data structures to define calendar data structures supported and recognized by the collaboration client 123. For example, and for a hierarchical meeting with two sub meetings, the plugin agent 124 generates three calendar data structures supported and recognized by the collaboration client 123, one for the overarching hierarchical meeting, one for a first of the two sub meetings, and one for a second of the two sub meetings.

Each calendar data structure includes all the necessary information needed by the collaboration client to insert the corresponding calendar data structure as a meeting within the meeting organizer's collaboration client 123 and provide the meeting details via a message to the corresponding attendees through the collaboration service 113. For example, using the aforementioned example and assuming there are 5 unique attendees for the hierarchical meeting, 3 unique attendees for the first sub meeting and 2 unique attendees for the second sub meeting, plugin agent 124 generates 3 unique messages recognized by collaboration client 123 and collaboration service 113. The first message includes 5 attendees with resources defined in the hierarchical object, the second message includes 3 attendees with resources defined for the first sub meeting, and the third message includes 2 attendees with resources defined for the second sub meeting. Of course, the meeting organizer does not need to receive any message so, assuming the hierarchical meeting and sub meetings in the above example there are 6 total attendees.

Additionally, plugin agent 124, when generating the meeting messages provides metadata associated with the attendee authorizations and a flag to indicate the hierarchical meeting type. The Collaboration client 123 hides the metadata within one or more designated non-visible fields of the messages and forwards the messages to the collaboration service 113. This permits the metadata for each message, when delivered to receiving attendee's message inbox by the collaboration service 113, to be inserted by the corresponding attendee's collaboration client 123 as a hierarchical meeting type associated with the meeting entry. This alerts the corresponding collaboration client 123 to initiate the corresponding plugin agent 124 when a receiving attendee attempts to modify the meeting entry.

Collaboration service 113 forwards the meeting messages to the designated attendees and their collaboration clients 123. The independent instances of each of the receiving attendee's collaboration clients 123 provides the corresponding message through the user interface via a message inbox view to the corresponding user. When a receiving attendee activates an option to accept the meeting, plugin agent 124 is initiated, identifies the hidden metadata, and generates a calendar data structure with the hidden metadata that is recognized by the corresponding collaboration client 123. Plugin agent 124 provides the calendar data structure with the hidden meta data to the corresponding collaboration client 123. The corresponding collaboration client 123 ignores and permits the hidden metadata in the calendar data structure and generates a meeting entry for a calendar of the attendee.

When the meeting organizer or an attendee with the proper attendee authorization selects a meeting entry from a corresponding calendar for viewing and modification, collaboration client 123 inspects the metadata and identifies the hidden metadata. This causes collaboration client 123 to initiate plugin agent 124. Plugin agent 124 obtains the hidden metadata and presents the GUI to the attendee for modifying the meeting criteria, meeting resources, meeting attributes, and/or attendee authorizations based on the attendee authorizations identified in the hidden metadata. For example, if an attendee is only permitted to add an attendee, then the GUI only permits the attendee to add an attendee and any other change is greyed out within the GUI so that the attendee is not permitted to make other changes. A permissible change proceeds in the same manner as was described above only to modify a given meeting entry on a calendar or on calendars associated with the affected attendees based on the change.

In an embodiment, the collaboration client 123 presents within the user interface a visual identifier to a user on their calendar which identifies a hierarchical meeting type. Although unnecessary, this visual identifier permits a user to readily determine that meeting entries are associated with one hierarchical meeting when the user's calendar depicts multiple separate meeting entries.

In an embodiment, one or more sub meetings of a hierarchical meeting is associated with a same resource (e.g., link to chat room or video conference). However, the attendees for the hierarchical meeting and sub meetings are different. Each attendee receives the same link but the meeting criteria, such as time required for attendance, varies by sub meeting. The attendees receive meeting entries on the calendar only for their required time slots. In this way, attendees associated with a first and second meeting do not have to drop a conference after time expires for the first meeting and sign back in to a different resource for the second conference since the attendees of the first meeting are already signed onto the resource used in both the first and second meetings.

In an embodiment, plugin agent 124 and/or 114 permits an existing hierarchical meeting to be modified to include an additional sub meeting, which was not originally defined in the hierarchical meeting. Any meeting organizer or attendee with the proper attendee authorization can perform this change.

In an embodiment, plugin agent 114 is optional. In an embodiment, plugin agent 124 is performed via cloud 110 by plugin agent 114 as described above. That is, when plugin agent 114 is provided, the processing discussed above for plugin agent 124 is performed by plugin agent 114 through interaction with the corresponding collaboration client 123 and/or collaboration service 113. In an embodiment, when plugin agent 114 is provided, plugin agent 114 and collaboration service 113 are on different clouds 110 or servers 110. In an embodiment, plugin agent 124 is subsumed as an embedded feature of an enhanced collaboration client 123 and/or enhanced collaboration service 113.

In an embodiment, the plugin agent 124 and/or 114 is a container. The container includes its own self-encapsulated operating environment, which interacts with the corresponding collaboration client 123 and/or collaboration service 113 via the API. In this embodiment, the container may include a different operating system from that which is used by the corresponding user-operated device 120 and the corresponding collaboration client 123. The independent OS and self-contained operating environment, permits the plugin agent 124 and/or 114 to execute in multiple different OS environments associated with different user-operated devices 120 and instances of collaboration client 123.

In an embodiment, plugin agent 124 and/or 114 uses the API to interact with collaboration service 113 for purposes of determining attendee availability when a new hierarchical meeting is being generated and/or when an existing hierarchical meeting is being modified. Attendee available is presented to the user for selection and determination of calendar dates and times of day available for each attendee.

System 100 permits a meeting organizer to define a single overarching meeting with sub meetings through a single session with plugin agent 124 and/or 114 using the GUI. The plugin agent 124 and/or 114 causes collaboration client 123 and collaboration service 113 to generate and send multiple meeting messages to different combinations of attendees. Each meeting message only includes the necessary resources needed for the corresponding meeting. Any single sub meeting associated with a hierarchical meeting can be individually modified/updated without necessitating all of the meetings be modified/updated. Large inter-department meetings with varied attendees and different intra-department sub meetings can be scheduled and managed via a single session with a corresponding plugin agent 124 and/or 114. Attendees receive calendar entries for just the times they are required to attend and can come and go without interruption.

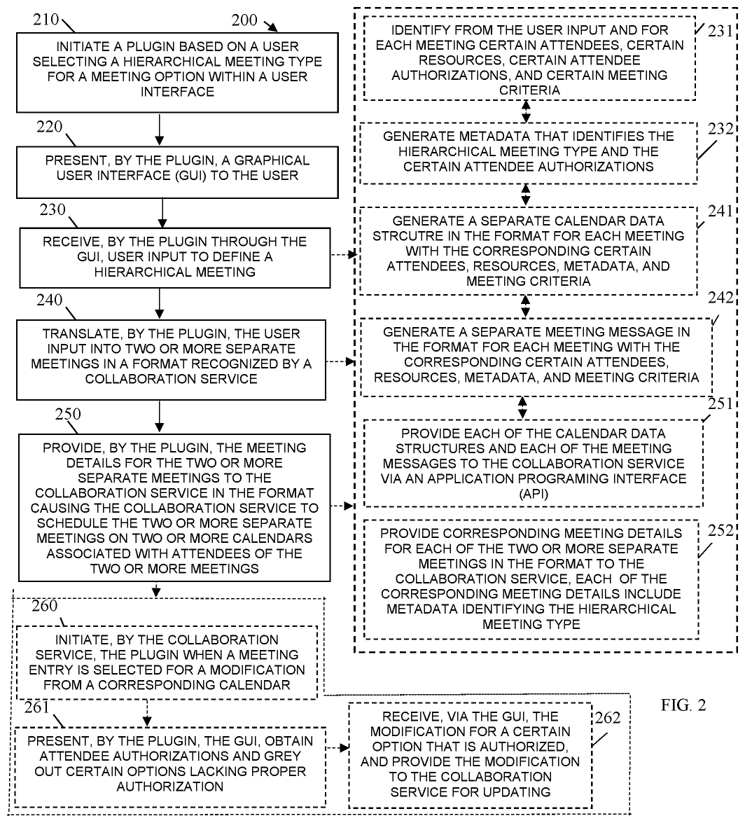

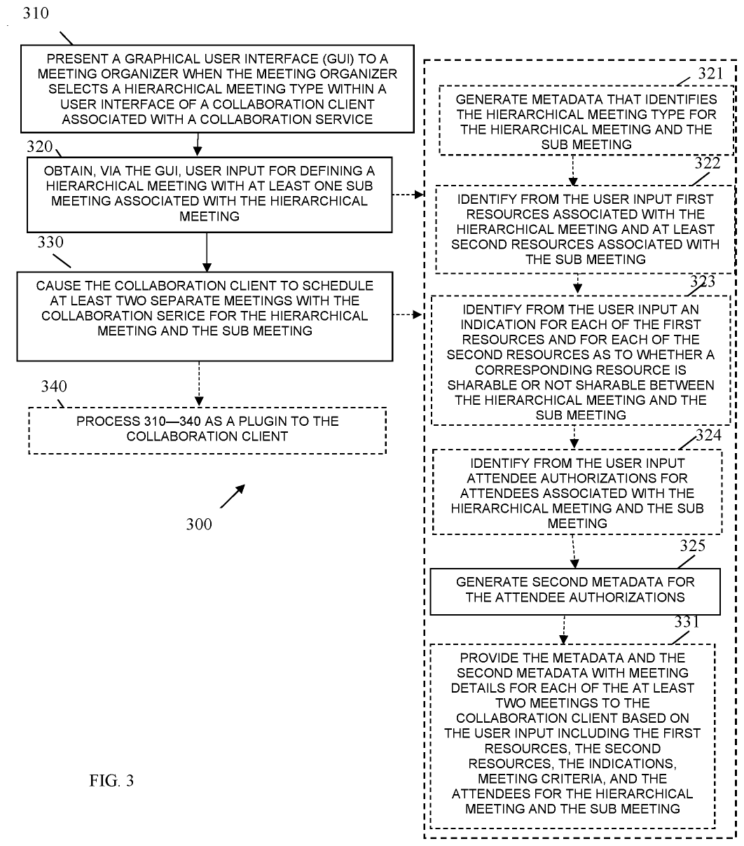

The above-referenced embodiments and other embodiments are now discussed within FIGS. 2-3. FIG. 2 is a diagram of a method 200 for hierarchical collaboration planning feature integration, according to an example embodiment. The software module(s) that implements the method 200 is referred to as a “hierarchical collaboration plugin integrator.” The hierarchical collaboration plugin integrator is implemented as executable instructions programmed and residing within memory and/or a non-transitory computer-readable (processor-readable) storage medium and executed by one or more processors of one or more devices. The processor(s) of the device that executes the hierarchical collaboration plugin integrator are specifically configured and programmed to process the hierarchical collaboration plugin integrator. The hierarchical collaboration plugin integrator may have access to one or more network connections during its processing. The network connections can be wired, wireless, or a combination of wired and wireless.

In an embodiment, the device that executes the hierarchical collaboration plugin integrator is cloud 110 or server 110. In an embodiment, the device that execute the hierarchical collaboration plugin integrator is user-operated device 120. In an embodiment, the hierarchical collaboration plugin integrator is all or some combination of 123, 124, 113, and/or 114.

At 210, the hierarchical collaboration plugin integrator initiates a plugin based on a user selecting a hierarchical meeting type for a meeting option within a user interface of a collaboration client or collaboration service. That is, when a user selects a meeting associated with a hierarchical meeting type, a plug to the collaboration client or collaboration service is initiated.

At 220, the hierarchical collaboration plugin integrator presents a GUI to the user. At 230, the hierarchical collaboration plugin integrator receives through the GUI user input to define a hierarchical meeting. The hierarchical collaboration plugin integrator uses the user input to create a hierarchical meeting object or data structure and one or more sub meeting objects or data structures.

In an embodiment, at 231, the hierarchical collaboration plugin integrator identifies from the user input and for each meeting certain attendees, certain resources, certain attendee authorizations, and certain meeting criteria. In an embodiment of 231 and at 232, the hierarchical collaboration plugin integrator generates metadata that identifies the hierarchical meeting type and the certain attendee authorizations.

At 240, the hierarchical collaboration plugin integrator translates the user input into two or more separate meetings in a format recognized by the collaboration client or collaboration service. In an embodiment of 232 and 240, at 241, the hierarchical collaboration plugin integrator generates a separate calendar data structure in the format for each meeting with the corresponding certain attendees, resources, metadata, and meeting criteria. In an embodiment of 241 and at 242, the hierarchical collaboration plugin integrator generates a separate meeting message in the format for each meeting with the corresponding certain attendees, resources, metadata, and meeting criteria.

At 250, the hierarchical collaboration plugin integrator provides the meeting details for the two or more separate meeting to the collaboration client or collaboration service in the format. This causes the collaboration client or collaboration service to schedule two or more separate meetings on two or more calendars associated with attendees of the two or more meetings. In an embodiment of 242 and 250, at 251, the hierarchical collaboration plugin integrator provides each of the calendar data structures and each of the meeting messages to the collaboration client or collaboration service via an API.

In an embodiment, at 252, the hierarchical collaboration plugin integrator provides corresponding meeting details for each of the two or more separate meetings in the format to the collaboration client or the collaboration service. Each of the corresponding meeting details include metadata identifying the hierarchical meeting type.

In an embodiment, at 260, the hierarchical collaboration plugin integrator initiates the plugin when a meeting entry is selected for modification from a corresponding calendar. The meeting entry associated with the hierarchical meeting type. In an embodiment of 260 and at 261, the hierarchical collaboration plugin integrator obtains the attendee authorizations and greys out certain options lacking proper attendee authorization. This prevents an attendee attempting a modification or change to the meeting entry from performing a modification for which the attendee has no authorization. In an embodiment of 261 and at 262, the receives, via the GUI, the modification for a certain option that is authorized, and the hierarchical collaboration plugin integrator provides the modification to the collaboration client or the collaboration service in the format for updating on the corresponding calendars.

FIG. 3 is a diagram of another method 300 for hierarchical collaboration planning feature integration, according to an example embodiment. The software module(s) that implements the method 300 is referred to as a “hierarchical planning integrator.” The hierarchical planning integrator is implemented as executable instructions programmed and residing within memory and/or a non-transitory computer-readable (processor-readable) storage medium and executed by one or more processors of a device. The processors that execute the hierarchical planning integrator are specifically configured and programmed for processing the hierarchical planning integrator. The hierarchical planning integrator may have access to one or more network connections during its processing. The network connections can be wired, wireless, or a combination of wired and wireless.

In an embodiment, the device that executes the hierarchical planning integrator is cloud 110 or server 110. In an embodiment, the device that executes the hierarchical planning integrator is user-operated device 120. In an embodiment, the hierarchical planning integrator is some combination or all of 113, 114, 123, 124, and/or method 200. The hierarchical planning integrator presents another and, in some ways, an enhanced processing perspective from that which was shown above for system 100 and/or method 200.

At 310, the hierarchical planning integrator presents a GUI to a meeting organizer when the meeting organizer selects a hierarchical meeting type within a user interface of a collaboration client associated with a collaboration service. At 320, the hierarchical planning integrator obtains, via the GUI, user input defining a hierarchical meeting with at least one sub meeting associated with the hierarchical meeting.

In an embodiment, at 321, the hierarchical planning integrator generates metadata that identifies the hierarchical meeting type for the hierarchical meeting and the sub meeting. In an embodiment of 321 and at 322, the hierarchical planning integrator identifies from the user input first resources associated with the hierarchical meeting and at least second resources associated with the sub meeting. In an embodiment of 322 and at 323, the hierarchical planning integrator identifies from the user input an indication for each of the first resources and each of the second resources as to whether a corresponding resource is sharable or not sharable between the hierarchical meeting and the sub meeting. In an embodiment of 323 and at 324, the hierarchical planning integrator identifies from the user input attendee authorizations for attendees associated with the hierarchical meeting and the sub meeting. In an embodiment of 324 and at 325, the hierarchical planning integrator generates second metadata for the attendee authorizations.

At 330, the hierarchical planning integrator causes the collaboration client to schedule at least two separate meetings with the collaboration service for the hierarchical meeting the sub meeting. In an embodiment of 325 and 330, at 331, the hierarchical planning integrator provides the metadata and the second metadata with meeting details for each of the two meetings to the collaboration client based on the user input, which at least includes the first resources, the second resource, the indications, meeting criteria, and the attendees for the hierarchical meeting and the sub meeting.

In an embodiment, at 340, the hierarchical planning integrator (310-340) is processed as a plugin to the collaboration client and/or the collaboration service. This was discussed at length above with respect to system 100 and method 200.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
initiating, by a collaboration service, a plugin based on a user selecting a hierarchical meeting type for a meeting option within a user interface of a collaboration service;
presenting, by the plugin, a graphical user interface (GUI), to the user;
receiving, by the plugin through the GUI, user input to define a hierarchical meeting;
translating, by the plugin, the user input into two or more separate meetings in a format recognized by the collaboration service;
providing, by the plugin, meeting details for the two or more separate meetings to the collaboration service in the format causing the collaboration service to schedule the two or more separate meetings on two or more calendars associated with attendees of the two or more separate meetings.

2. The method of claim 1 further comprising, initiating, by the collaboration service, the plugin when a meeting entry associated with at least one of the two or more separate meetings is selected for a modification from a corresponding calendar by a corresponding attendee.

3. The method of claim 2 further comprising, presenting, by the plugin, the GUI to the corresponding attendee, obtaining attendee authorizations from metadata associated with the meeting entry, and greying out certain options within the GUI that the corresponding attendee lacks a proper attendee authorization for making the modification.

4. The method of claim 3 further comprising, receiving, via the GUI from the corresponding attendee, the modification for a certain option that the corresponding attendee is authorized to make based on the attendee authorizations, and providing, by the plugin, the modification for the meeting entry to the collaboration service causing the collaboration service to update the meeting entry on corresponding calendars of corresponding attendees associated with the meeting entry.

5. The method of claim 1, wherein receiving further includes identifying from the user input and for each of the two or more separate meetings certain attendees, certain resources, certain attendee authorizations, and certain meeting criteria.

6. The method of claim 5, wherein identifying further includes generating metadata that identifies the hierarchical meeting type and the certain attendee authorizations.

7. The method of claim 6, wherein translating further includes generating a separate calendar data structure in the format for a corresponding meeting entry for each of the two or more separate meetings with corresponding certain attendees, corresponding certain resources, corresponding metadata, and corresponding certain meeting criteria.

8. The method of claim 7, wherein translating further includes generating a separate meeting message in the format for each of the two or more separate meetings with the corresponding certain attendees, the corresponding certain resources, the corresponding metadata, and the corresponding certain meeting criteria.

9. The method of claim 8, wherein providing further includes providing each of the calendar data structures and each of the meeting messages to the collaboration service via an application programming interface.

10. The method of claim 1, wherein providing further includes providing corresponding meeting details for each of the two or more separate meetings in the format to the collaboration service, wherein each of the of the corresponding meeting details include metadata identifying the hierarchical meeting type.

11. A method, comprising:
presenting a graphical user interface (GUI) to a meeting organizer when the meeting organizer selects a hierarchical meeting type within a user interface of a collaboration client associated with a collaboration service;
obtaining, via the GUI, user input for defining a hierarchical meeting and at least one sub meeting associated with the hierarchical meeting; and
causing the collaboration client to schedule at least two separate meetings with the collaboration service for the hierarchal meeting and the at least one sub meeting based on the user input.

12. The method of claim 11, wherein obtaining further include generating and metadata that identifies the hierarchical meeting type for the hierarchical meeting and the at least one sub meeting.

13. The method of claim 12, wherein obtaining further includes identifying from the user input, first resources associated with the hierarchical meeting and at least second resources associated with the at least one sub meeting.

14. The method of claim 13, wherein obtaining further includes identifying from the user input, an indication for each of the first resources and for each of the at least second resources as to whether a corresponding resource is sharable or not sharable between the hierarchical meeting and the at least one sub meeting.

15. The method of claim 14, wherein obtaining further includes identifying from the user input, attendee authorizations for attendees associated with the hierarchical meeting and the at least one sub meeting.

16. The method of claim 15, wherein obtaining further include generating second metadata for the attendee authorizations.

17. The method of claim 16, wherein causing further includes providing the metadata and the second metadata with meeting details for each of the at least two meetings to the collaboration client based on the user input including the first resources, the at least second resources, the indications, meeting criteria, and the attendees for the hierarchical meeting and the at least one sub meeting.

18. The method of claim 11 further comprising, processing the method as a plugin to the collaboration client.

19. A system, comprising:
at least one server comprising a processor and a non-transitory computer-readable storage medium;
the non-transitory computer-readable storage medium comprising executable instructions; and
the executable instructions when executed by the processor cause the processor to perform operations comprising:
using an application programming interface (API) to interact with a collaboration client as a plugin to the collaboration client;
presenting a graphical user interface (GUI) to a meeting organizer when the user selects a hierarchical meeting type from a user interface of the collaboration client;
obtaining, from the GUI, user input provided by the meeting organizer that defines a hierarchical meeting and at least one sub meeting within the hierarchical meeting;
translating the user input into separate meetings with separate meeting details in a format recognized by the collaboration client;
generating metadata that identifies the hierarchical meeting type and including the metadata with each of the separate meeting details; and
providing each of the separate meeting details to the collaboration client causing the collaboration client to schedule the separate meetings and including the metadata with corresponding separate meeting details.

20. The system of claim 19, the executable instructions associated with obtaining further includes identifying attendee authorizations from the user input associated with attendees and access rights of the attendees and further permitting, after each of the separated meetings are scheduled and via the GUI, a given attendee with given attendee authorizations to modify, cancel, or change one or more of the hierarchical meeting and the at least one sub meeting.
